(19) United States
(12) Patent Application Publication
(10) Pub. No.: US 2014/0181652 A1
(43) Pub. Date: Jun. 26, 2014

(54) Contextual and Personalized Help

(71) Applicants: Timothy A. Stanke, Los Gatos, CA (US); Qing Guo, Mountain View, CA (US); Shoeb A. Omar, Sunnyvale, CA (US)

(72) Inventors: Timothy A. Stanke, Los Gatos, CA (US); Qing Guo, Mountain View, CA (US); Shoeb A. Omar, Sunnyvale, CA (US)

(21) Appl. No.: 13/723,951

(22) Filed: Dec. 21, 2012

(51) Int. Cl. H04L 29/08; G06F 3/0481

(52) U.S. Cl. CPC H04L 67/22; G06F 3/0481
USPC 715/708; 709/204

(57) ABSTRACT

In one embodiment, a method includes receiving, by one or more computing devices, a help query from a user of a social-networking system. The computing devices identify help content responsive to the help query based at least in part on a state of an account of the user on the social-networking system and activity by the user on the social-networking system. The computing devices send the help content for presentation to the user.

### TECHNICAL FIELD

This disclosure generally relates to a social-networking system.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, a user of a social-networking system may request and receive assistance in using one or more features of the social-networking system. The user may request assistance, for example, via a help query. The social-networking system may identify help content in response to the user's help query based on one or more of the following: the context of the user's help query (e.g., which webpage of the social-networking system the user is viewing when the user submits a help query), the user's activity on the social-networking system, the state of the user's account on the social-networking system, or a device of the user. The social-networking system may then provide the help content for display to the user, via, for example, a help interface on the current webpage or via a separate help webpage.

### BRIEF DESCRIPTION OF THE DRAWINGS

FIG. 1 illustrates an example network environment associated with a social-networking system.

FIG. 2 illustrates an example social graph.

FIG. 3 illustrates an example method for identifying help content.

FIG. 4 illustrates an example computer system.

### DESCRIPTION OF EXAMPLE EMBODIMENTS

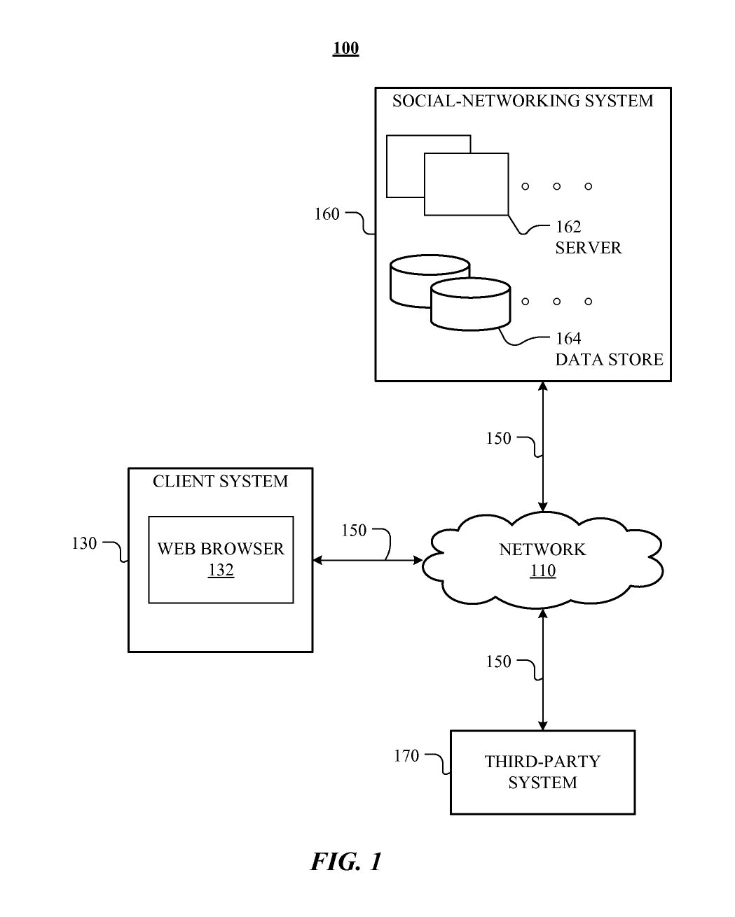

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 164 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g. relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g. third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

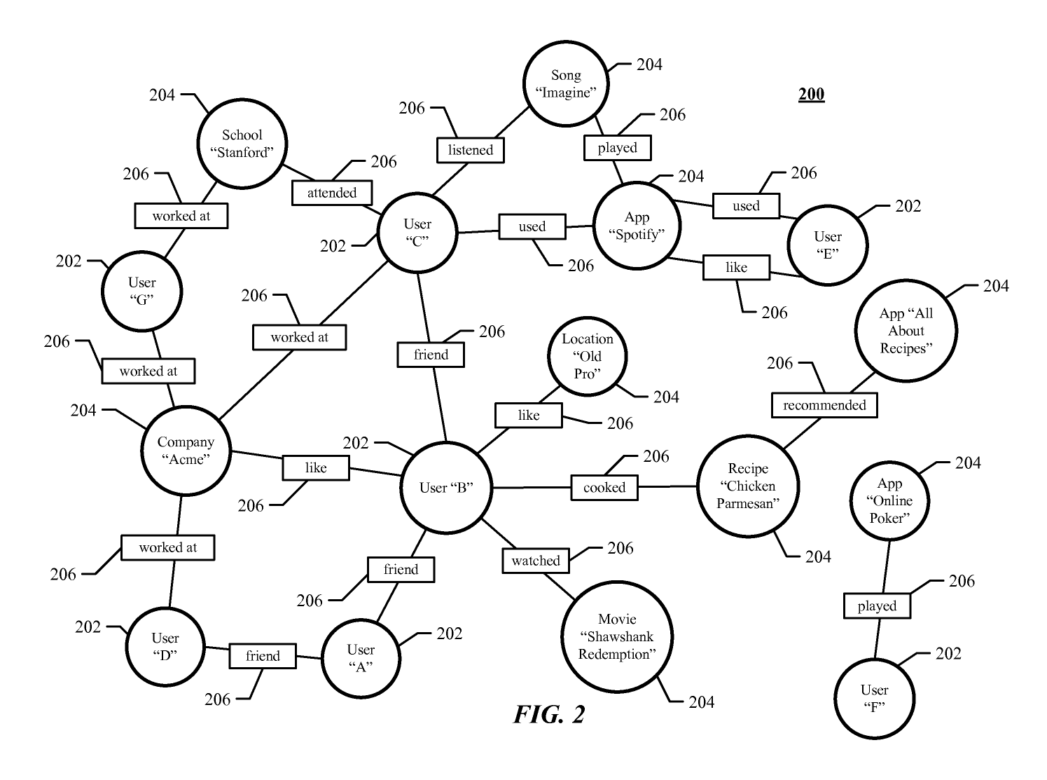

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g. an enterprise, business, or third-party application), or a group (e.g. of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g. an image of the cover page of a book); a location (e.g. an address or a geographical location); a website (which may be associated with a URL); contact information (e.g. a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g. “eat”), causing a client system 130 to send to social-networking system 160 a message indicating the user's action. In response to the message, social-networking system 160 may create an edge (e.g. an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, a user of social-networking system 160 may require assistance in using one or more features of the social-networking system. As an example, a user attempting to create a photo album to store and display photos within the social-networking system may need assistance in creating or modifying aspects of the photo album. The user may, in particular embodiments, request assistance via a help query. The help query may, for example, include a user click on a “help” link, or a user help-topic search query in a help interface. In particular embodiments, the user may query for help by clicking a “help” link to navigate to a help webpage (or set of webpages) within the social-networking system. In other embodiments, the user may click a “help” link, opening a display of a help interface (a graphical user interface or GUI) without navigating to a separate help webpage within the social-networking system (e.g., an inline help interface). The user may query for help by entering a help-topic search query in the help interface.

In particular embodiments, the user may, within the help interface, enter a help-topic search query to obtain assistance in using one or more features of the social-networking system. For example, the user may enter the search query “how to create a photo album” within a help-topic search box of the help interface. The help interface may display, based on the terms of the search query, help topics relevant to the search query. For example, the help interface may display help topics such as “How do I upload photos and create a new album?” or “How do I upload photos or videos to a group?” in response to the query “how to create a photo album.” In particular embodiments, the help interface may display help topics based on one or more terms of a user search query as the user enters the query (e.g., before the user completes entering the entire search query), dynamically changing the displayed help topics as the search query changes. For example, after the user types “how to create” (and before the user completes typing the entire search query, “how to create a photo album”), the help interface may display help topics related to creating different objects within the social-networking system, such as “How do I upload photos and create a new album?” or “How do I create a group?”

In particular embodiments, a subset of relevant help topics is displayed to the user within the help interface, and a link to navigate to the full set of relevant help topics (e.g., on a separate help webpage) is provided to the user within the help interface. For example, the top N (e.g., top 10, top 8, etc.) help topics matching a user search query may be displayed within a help interface. As another example, the top N help topics in terms of popularity among users of the social-networking system may be displayed within the help interface. As yet another example, the top N help topics associated with the most severe user problems (e.g., in terms of usage impact, measured using user surveys) may be displayed within the help interface. Any suitable ranking method may be used to determine a subset of relevant help topics to display to a user within a help interface of the social-networking system.

In particular embodiments, each of the help topics displayed within the help interface may include a link that the user may click to display help instructions for the particular help topic within the help interface. For example, if the user clicks on the help topic link “How do I upload photos and create a new album?” within the help interface, the user interface may expand to include help instructions (including, e.g., text, images, videos, and links) for the topic of uploading photos and creating new albums. The user interface may continue to display the other relevant help topics in its expanded mode. Additionally, the user interface may display multiple sets of help instructions for help topics selected by (e.g., clicked on by) the user. The user may return the help interface to an un-expanded mode by again clicking links associated with expanded help topics. In particular embodiments, the user may click a link associated with a help topic displayed within the help interface directing the user to a separate help webpage for the selected topic. The help webpage may include the same, different, or overlapping information in comparison to the expanded help instructions displayed in the help interface for the same topic. In particular embodiments, the help instructions may both provide step-by-step instructions and interactive elements that allow a user to directly interact with the social-networking system to follow and implement these instructions. For example, help instructions (e.g., within a help interface or on a help webpage) for creating a photo album may include an interactive element such as a link or a photo uploading interface that allows the user to directly upload photos to create a photo album.

In particular embodiments, relevant help topics or other help content displayed to a user within a help interface may be identified or determined based on the context of the user's help query. As an example, the webpage a user is browsing within the social-networking system when the user clicks a “help” link (the help query) may be used to determine which topics are displayed to the user, for example in a help interface. For example, if a user is looking at a webpage associated with a user group within the social-networking system, and if the user clicks the “help” link while on this webpage, the help interface may display (without any further user input) a list of help topics relevant to groups within the social-networking system. The help topics may be broad categories of help topics. For example, the help topics may include “Managing Your Group” or “Group Chat.” Each of these broad-category help topics may be selected by the user to display, within the help interface, specific help topics related to the broad category selected. For example, the user may select “Group Chat” to display help topics including “How do I chat with more than one friend at once?” Furthermore, the help interface may display a link to a separate help webpage with all help topics relevant to groups. Additionally, the help interface may also provide a link to a messaging application that, when clicked, pre-fills a message to one or more other users connected with the user in the social-networking system; the message may contain a pre-filled question relating to one or more help topics selected by the user. In particular embodiments, the social-networking system may determine an identifier associated with the webpage a user is browsing when the user clicks a “help” link (the help query). The social-networking system may then retrieve (e.g., from a database) help topics or other help content that is determined to be associated with or relevant to the identifier. As an example, the social-networking system may have identifiers that correspond to webpages of each of the following types (corresponding, e.g., to social graph nodes): photos, albums, user profiles, user groups, events, user posts, and “generic” (a catchall or fallback category for all other types of webpages). The social-networking system may determine which help topics or help content are associated with or relevant to an identifier in any suitable way including, for example, machine-learning algorithms or manual curation. In particular embodiments, the context of the user's help query may include the location and type of device the user is using to access the social-networking system (e.g., a desktop computer, a smartphone, a tablet computer, etc.). For example, if the user is accessing the social-networking system from a smartphone and the user is looking at a webpage associated with a photo album, if the user clicks the “help” link while on this webpage, the help interface may display (without any further user input) a list of help topics relevant to the mobile uploading of pictures to a photo album. In particular embodiments, particular features of the social-networking system may only be available to a subset of the users of the social-networking system, and this information may be used by the social-networking system to determine which help topics or help content are displayed to a given user. For example, a particular product or feature of the social-networking system may be available only to English-speaking users in the United States who have been using the social-networking system for more than 100 days. In this example, the help content displayed to an English-speaking user in the United States who has been using the social-networking system for more than 100 days may be different than the help content displayed to a user who does not fall into this subset of users.

In particular embodiments, relevant help topics or other help content displayed to a user within a help interface may be identified or determined based on information associated with the user in the social-networking system. As an example, an account state of the user in the social-networking system may be used to identify help content to display to the user in response to the user's help query (e.g., the user clicking on a “help” link). If, for example, the user's account is blocked from sending requests to connect with other users on the social-networking system, the help content displayed to the user may reflect this information. One help topic that may be displayed in the help interface to a user with such an account block may be “Help with adding a friend.” As another example, the help interface may display to the user an indication that the user is currently under an account block that will last until a specified date and time. Examples of information associated with the account state of a user in the social-networking system include: the age of the user's account, the number of other users connected to the user in the social-networking system, any type of feature of the social-networking system that the user is blocked from using or accessing, the status of a payment by or to the user in the social-networking system, the identity of the user (e.g., whether the user is a developer of software associated with the social-networking system, such as a third-party application), whether the user is an advertiser associated with the social-networking system, or whether the user is logged in to the social-networking system. As an example, if the user is not logged in to the social-networking system, the help content may include login instructions. As another example, if a user has uploaded content to the social-networking system that violates a policy of the social-networking system, the user's account may be marked with an indication that the user must undergo an educational flow (e.g., a set of screens regarding the policies of the social-networking system). The indication that the user has recently participated in an educational flow is an example of information associated with the user's account state that may be used to determine relevant help topics or content (e.g., regarding the educational flow or the policy violation) to be displayed to the user in a help interface.

Another example of information associated with the user in the social-networking system is the activity of the user in the social-networking system. The activity of the user in the social-networking system may be used to identify or determine relevant help topics or other help content to display to the user within a help interface. One example of user activity in the social-networking system is an engagement level of the user. For example, a user who uses the social-networking system less frequently may receive help content that is tailored to helping the user become more engaged with the social-networking system. The user's usage (including, e.g., usage type and usage level) of different products or services in the social-networking system may also be used to determine relevant help content. For example, if a user has never before uploaded a picture to the social-networking system and the user is looking at a webpage associated with a photo album, if the user clicks the “help” link while on this webpage, the help interface may display help content tailored to a user with limited or no experience with the photo album feature of the social-networking system. In contrast, a user who regularly uses the photo album feature may receive help content tailored to more advanced photo album topics. As another example, if the user is a developer of software associated with the social-networking system and the user uses a software development kit, the social-networking system may provide help content tailored to software development. The type of activity information related to different products or services may be as specific as desired, for example, whether the user has ever deleted a photo or tagged (e.g., identified) another user in a photo on the social-networking system. In particular embodiments, the social-networking system may store information associated with the user's fluency level with respect to various products or services of the social-networking system (e.g., a user “scorecard”). This may allow the user to receive help content tailored to the user's proficiency with respect to each product or service of the social-networking system. In particular embodiments, either the social-networking system or a third party may store information associated with the user's usage with respect to third-party applications (or other third-party products or features) associated with the social-networking system. The social-networking system may provide a help content API for third-party developers to provide help content. The user's spending history may also be used to identify or determine relevant help content to display to the user. For example, if the user is an advertiser whose spending activity drops significantly, the help interface may include help content focused on advertising issues. The user's recent search history activity or recently-posted content activity within the social-networking system may also be used to determine relevant help content for display to the user. For example, if the user searches (e.g., within the general search interface for the social-networking system) “how to upload a picture,” the help interface may display help content relevant to picture uploads. As another example, if the user posts that a certain feature of the social-networking system “doesn't work,” the help interface may display help content that allows the user to report a bug for the feature.

Any combination of the above techniques or methods may be used to identify or determine relevant help topics or help content for display to a user within a help interface (or on a separate help webpage) within a social-networking system. The context of the user's help query, the state of the user's account in the social-networking system, and the user's activity in the social-networking system may be used alone or in conjunction with one another to deliver contextual and personalized help content to the user.

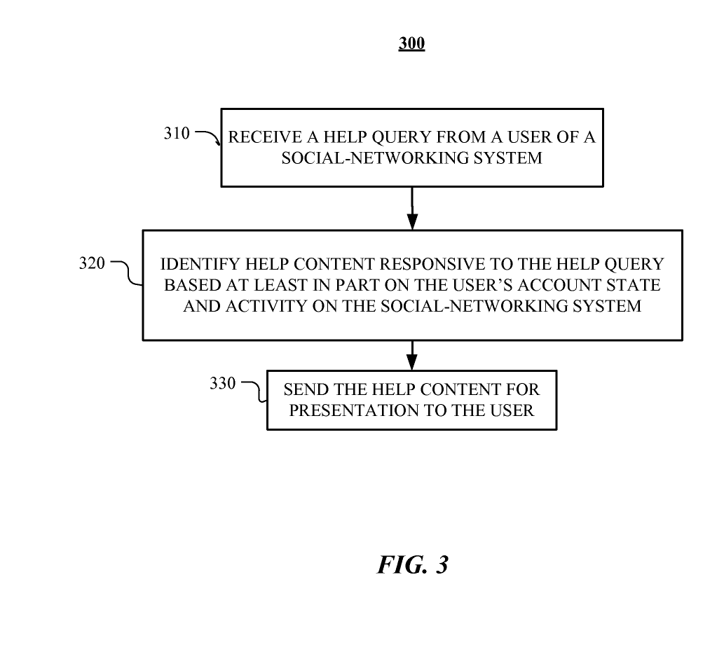

FIG. 3 illustrates an example method 300 for identifying help content. The method may begin at step 310, where one or more computing devices (e.g., servers 162 of social-networking system 160) receive a help query from a user of a social-networking system (e.g., a user click on a “help” link, or a user help-topic search query in a help interface). At step 320, the one or more computing devices identify help content responsive to the help query based at least in part on a state of an account of the user on the social-networking system and activity by the user on the social-networking system. At step 330, the one or more computing devices send the help content for presentation to the user. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

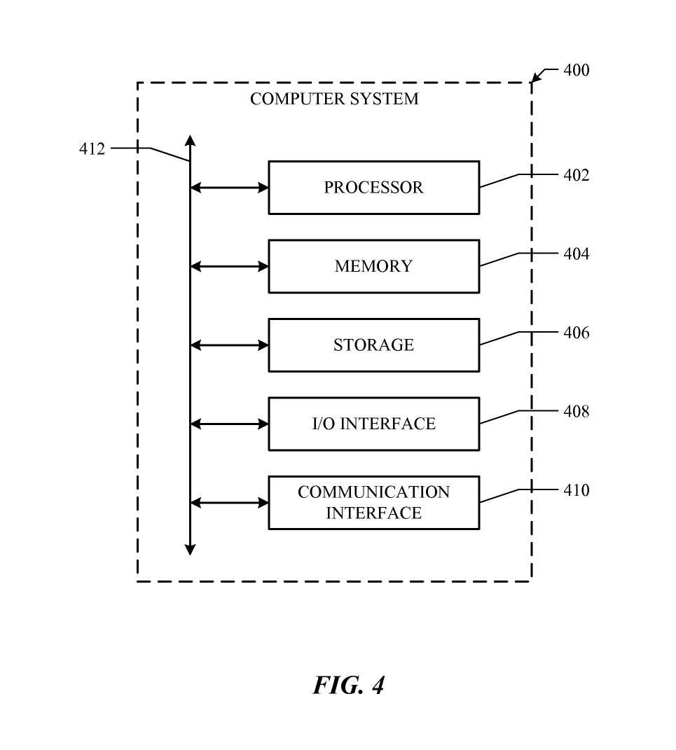

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
receiving, by one or more computing devices, a help query from a user of a social-networking system;
identifying, by one or more computing devices, help content responsive to the help query based at least in part on:
a state of an account of the user on the social-networking system; and
activity by the user on the social-networking system;
sending, by one or more computing devices, the help content for presentation to the user.

2. The method of claim 1, wherein the state of the account of the user on the social-networking system comprises:
an age of the account;
a number of other users connected to the user on the social-networking system;
features of the social-networking system that the user is blocked from;
a status of a payment by the user on the social-networking system;
whether the user is a developer of software associated with the social-networking system;
whether the user is an advertiser associated with the social-networking system; or
whether the user is logged in to the social-networking system.

3. The method of claim 1, wherein activity by the user on the social-networking system comprises:
an engagement level of the user on the social-networking system;
a fluency level of the user with respect to a product that the help query relates to;
search queries entered by the user; or
posts by the user on the social-networking system.

4. The method of claim 3, wherein the product is a service of the social-networking system.

5. The method of claim 3, wherein the product is a software development kit.

6. The method of claim 1, wherein the help content responsive to the help query is identified further based at least in part on a webpage associated with the social-networking system that is being presented to the user when the help query is received.

7. The method of claim 1, wherein the help content responsive to the help query is identified further based at least in part on a computing device that the user is interacting with when the help query is received.

8. The method of claim 1, wherein the social-networking system comprises a graph comprising a plurality of nodes and edges connecting the nodes, at least one node in the graph corresponding to the first user.

9. The method of claim 1, wherein the help query is sent in response to the user selecting an interactive element of a graphical user interface (GUI) requesting help.

10. The method of the claim 1, wherein sending the help content for presentation to the user comprises sending interactive links to the help content for presentation to the user.

11. One or more computer-readable non-transitory storage media embodying software that is operable when executed to:
receive a help query from a user of a social-networking system;
identify help content responsive to the help query based at least in part on:
a state of an account of the user on the social-networking system; and
activity by the user on the social-networking system;
send the help content for presentation to the user.

12. The media of claim 11, wherein the state of the account of the user on the social-networking system comprises:
an age of the account;
a number of other users connected to the user on the social-networking system;
features of the social-networking system that the user is blocked from;
a status of a payment by the user on the social-networking system;
whether the user is a developer of software associated with the social-networking system;
whether the user is an advertiser associated with the social-networking system; or
whether the user is logged in to the social-networking system.

13. The media of claim 11, wherein activity by the user on the social-networking system comprises:
an engagement level of the user on the social-networking system;
a fluency level of the user with respect to a product that the help query relates to;
search queries entered by the user; or
posts by the user on the social-networking system.

14. The media of claim 13, wherein the product is a service of the social-networking system.

15. The media of claim 13, wherein the product is a software development kit.

16. The media of claim 11, wherein the help content responsive to the help query is identified further based at least in part on a webpage associated with the social-networking system that is being presented to the user when the help query is received.

17. The media of claim 11, wherein the help content responsive to the help query is identified further based at least in part on a computing device that the user is interacting with when the help query is received.

18. The media of claim 11, wherein the social-networking system comprises a graph comprising a plurality of nodes and edges connecting the nodes, at least one node in the graph corresponding to the first user.

19. The media of claim 11, wherein the help query is sent in response to the user selecting an interactive element of a graphical user interface (GUI) requesting help.

20. The media of claim 11, wherein sending the help content for presentation to the user comprises sending interactive links to the help content for presentation to the user.
